(19) United States
(12) Patent Application Publication
(10) Pub. No.: US 2019/0372825 A1
(43) Pub. Date: Dec. 5, 2019

(54) COMMUNICATION APPARATUS, COMMUNICATION METHOD, AND RECORDING MEDIUM

(71) Applicant: FUJITSU LIMITED, Kawasaki-shi (JP)

(72) Inventor: Junichi Suga, Ota (JP)

(73) Assignee: FUJITSU LIMITED, Kawasaki-shi (JP)

(21) Appl. No.: 16/419,181

(22) Filed: May 22, 2019

(30) Foreign Application Priority Data
Jun. 5, 2018 (JP) 2018-107976

(51) Int. Cl. H04L 12/24; G06F 16/182

(52) U.S. Cl. CPC H04L 41/0266; H04L 41/0806; H04L 41/0893; G06F 16/1824

(57) ABSTRACT

A communication apparatus includes a memory configured to store a distributed ledger in which metadata of data that is acquirable through any one of a plurality of communication apparatuses that belongs to a network; and a processor coupled to the memory and configured to: control for sharing the distributed ledger among the plurality of communication apparatuses, determine in which one of a plurality of division networks that are obtained by dividing the network participation takes place, using the same rule as any other communication apparatus that belongs to the network, when a communication situation of the network satisfies a predetermined condition, and control for sharing the distributed ledger among communication apparatuses in the division network that is determined.

### CROSS-REFERENCE TO RELATED APPLICATION

This application is based upon and claims the benefit of priority of the prior Japanese Patent Application No. 2018-107976, filed on Jun. 5, 2018, the entire contents of which are incorporated herein by reference.

### FIELD

The embodiments discussed herein are related to a communication apparatus, a communication method, and a recording medium.

### BACKGROUND

In recent years, with exchange and utilization of various pieces of digitized data, there has been an increasing expectation about digital transformation for creating a new service or business. As one method of exchanging data in a case where the data is distributed to multiple bases such as different companies or organizations, it is also proposed that an electronic file is shared by performing peer-to-peer communication between devices. At this time, in order to strengthen security, in some cases, a blockchain technology is used. For example, a provider of data may store data to be provided in a server of the provider of data and may register attribute information on the data to be provided in a distributed ledger, in a state of being associated with a place where the data is stored. In this case, when acquiring information on a place where data that is going to be acquired is stored, a user who uses the data may have access to the data using the distributed ledger.

As a related technology, a management method is proposed in which, when a request for establishment groups is received, a selected group management node is caused to measure quality of a network with any other subsystem and in which the group is determined based on an obtained result (Japanese Laid-open Patent Publication No. 2013-206112). A network system is also known in which at the request of a third party client computer, data may be directly transmitted between two computer devices (for example, Japanese National Publication of International Patent Application No. 2014-503141).

Related technologies are disclosed in the following documents: Japanese Laid-open Patent Publication No. 2013-206112 and Japanese National Publication of International Patent Application No. 2014-503141.

### SUMMARY

According to an aspect of the embodiments, a communication apparatus includes a memory configured to store a distributed ledger in which metadata of data that is acquirable through any one of a plurality of communication apparatuses that belongs to a network; and a processor coupled to the memory and configured to: control for sharing the distributed ledger among the plurality of communication apparatuses, determine in which one of a plurality of division networks that are obtained by dividing the network participation takes place, using the same rule as any other communication apparatus that belongs to the network, when a communication situation of the network satisfies a predetermined condition, and control for sharing the distributed ledger among communication apparatuses in the division network that is determined.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a communication method according to an embodiment;

FIG. 2 is a diagram illustrating an example of a configuration of a communication apparatus;

FIG. 3 is a diagram for describing an example of a hardware configuration of the communication apparatus;

FIG. 4 is a flowchart for describing an example of a method of dividing a network;

FIG. 5 is a diagram for describing an example of a method of generating a network group;

FIG. 6 is a diagram for describing an example of verification processing;

FIG. 7 is a flowchart for describing an example of a method of managing metadata according to a first embodiment;

FIG. 8 is a diagram for describing an example of generating the network group;

FIG. 9 is a sequence diagram for describing an example of the method of managing metadata according to the first embodiment;

FIG. 10 is a sequence diagram for describing an example of a method of referring to metadata according to the first embodiment;

FIG. 11 is a diagram for describing an example of processing of a request result;

FIG. 12 is a sequence diagram for describing an example of a method of acquiring data according to the first embodiment;

FIG. 13 is a diagram for describing an example of a method of managing metadata according to a second embodiment;

FIG. 14 is a flowchart for describing an example of the method of managing metadata according to the second embodiment;

FIG. 15 is a sequence diagram for describing an example of the method of managing metadata according to the second embodiment;

FIG. 16 is a sequence diagram for describing an example of a method of referring to metadata according to the second embodiment;

FIG. 17 is a sequence diagram for describing an example of a method of acquiring data according to the second embodiment; and

FIG. 18 is a sequence diagram for describing an example of the method of acquiring data according to the second embodiment.

### DESCRIPTION OF EMBODIMENTS

In a system in which an attribute of data that is providable or a place for storing data is recorded in a distributed ledger that is a blockchain and in which a terminal that is to acquire data has access to data referring to the distributed ledger, as a network size increases, an amount of information that is recorded in the distributed ledger also increases. For this reason, there is a problem in that in a large network, a capacity of a memory that is used for an apparatus on the network to perform storing in the distributed ledger increases massively.

Implementation examples of communication apparatus, a communication method, and a communication program according to an embodiment, which are disclosed in the present application, will be described in detail below with reference to the drawings. Each of these implementation examples is an example and is not limited to a configuration and the like.

### Embodiment

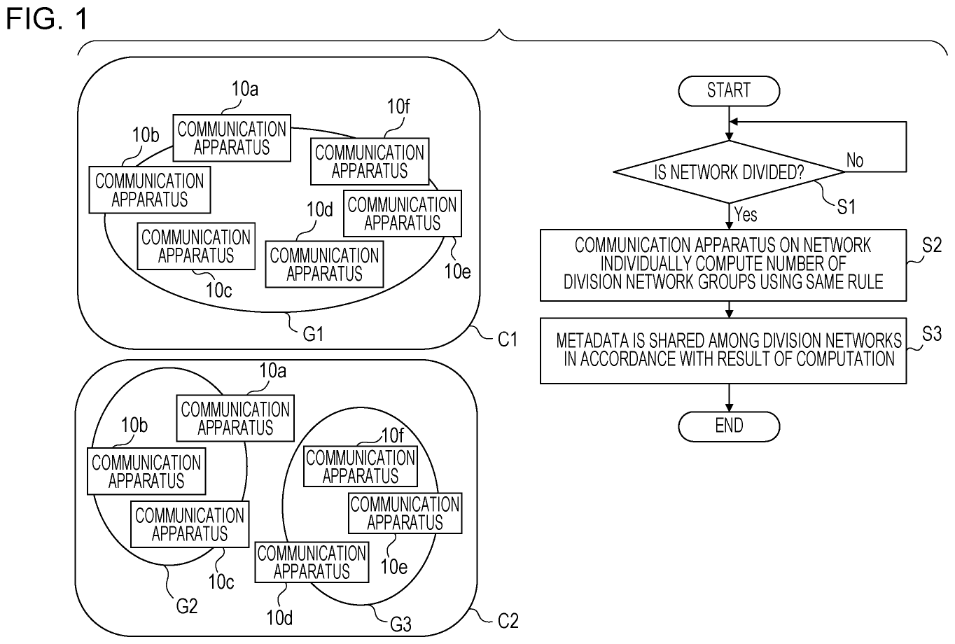

FIG. 1 is a diagram illustrating an example of a communication method according to an embodiment. In a state that is illustrated in a case C1, six communication apparatuses 10, communication apparatuses 10a to 10f belong to one network, a network G1. It is assumed that metadata of data that is acquirable through any of the communication apparatuses 10a to 10f is shared among the communication apparatuses 10 that belongs to the network using a distributed ledger that is available in a blockchain technology. It is possible that, using the distributed ledger, it is checked whether or not the metadata is legitimate or whether or not the access to the metadata and the data is available.

In a network on which the distributed ledger is shared, when an amount of information that is recorded in the distributed ledger increases massively, a capacity of a memory that is used for an individual communication apparatus 10 to retain the distributed ledger increases. For this reason, it is assumed that each communication apparatus 10 retain in advance a rule for determining a condition for dividing a network and determining to which one of the multiple division networks that result from dividing the network the communication apparatus 10 belongs.

Each communication apparatus 10, as illustrated in Step S1 in a flowchart in FIG. 1, suitably determines whether or not a condition for dividing the network occurs. The communication apparatus 10 waits until the condition for dividing the network occurs (No in Step S1).

When the condition for dividing the network occurs, the communication apparatus 10 on the network individually computes the number of division networks using the same rule that is set in advance (Step S2). Included in the rule that is set is information such as the number of division networks that are generated from the network, or the number of communication apparatuses 10 that are included in each division network. With the computation of the number of division networks, the communication apparatus 10 may know to which one of the division networks the communication apparatus 10 itself belongs. Each communication apparatus 10 may know to which one of the division networks any other communication apparatus 10 on the network also belongs.

Each communication apparatus 10 not only participates in the division network in accordance with a result of the computation, but also shares the metadata with the division networks in which the communication apparatus 10 participates (Step S3). At this time, in order to share the metadata, the distributed ledger may be used among the division networks. The individual communication apparatus 10 determines an apparatus that is included individually in the division network, but because any one of the apparatuses performs the computation according to the same rule, the result of the computation of the number of division networks in any one of the communication apparatuses 10 is the same.

A case C2 is an example of the computation of the number of division networks. In an example in FIG. 1, the communication apparatuses 10a to 10c belong to a network G2, and the communication apparatuses 10d takes place 10f belong to a network G3. As in the case C2, the number of division networks is computed, and then the metadata of the data that is acquirable through any one of the communication apparatuses 10a to 10c is shared among the communication apparatuses 10a to 10c. In the same manner, the metadata of the data that is acquirable through any one of the communication apparatuses 10d to 10f is shared among the communication apparatuses 10d to 10f.

Therefore, in a system that uses the communication method according to the embodiment, the capacity of the metadata that is retained by each communication apparatus 10 increases massively, and thus there is a concern that the communication apparatus 10 will run short of the memory capacity. Within the division network, transmission and reception of the data that corresponds to the metadata which is shared is possible. As will be described below, the transmission and reception of data over the division networks is also possible.

### Apparatus Configuration

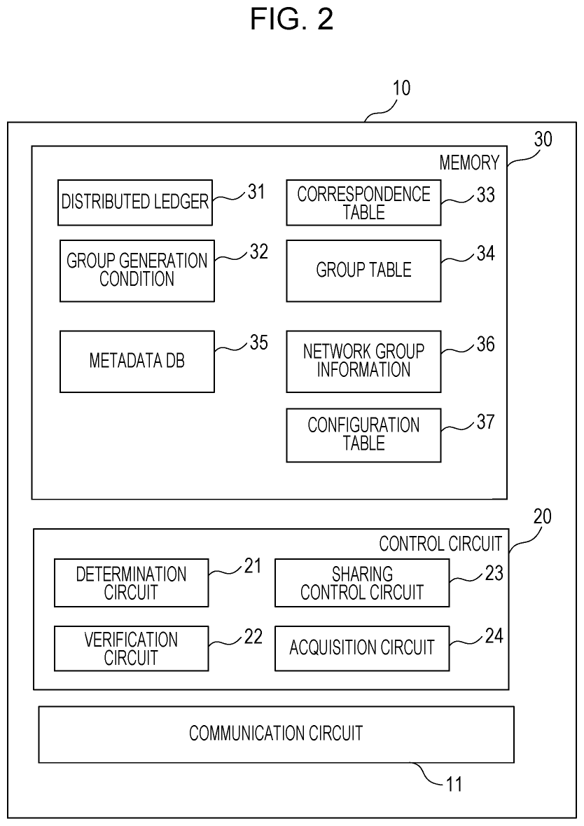

FIG. 2 is a diagram for describing an example of a configuration of the communication apparatus 10. The communication apparatus 10 includes a communication circuit 11, a control circuit 20, and a memory 30. Stored in the memory 30 are a distributed ledger 31, a group generation condition 32, a group table 34, a metadata DB 35 and a network group information 36. Further stored in the memory 30 is any one of a correspondence table 33 and a setting table 37. The metadata database (DB) 35 retains the metadata of the acquirable data. The distributed ledger 31 retains a history of the access to metadata and the access to data, which is used in order to share the metadata, on the pre-division network or on the division network (a network group) that is obtained by the division. When the metadata is registered, or when post-register access and the access to data is available, authentication is suitably performed, and a result of the access is recorded in the distributed ledger 31. Because of this, by the distributed ledger 31, a trail of a sequence of operations from the metadata registration to the access to the data may be checked.

The group generation condition 32 is a condition that has to be satisfied when generating the network group (the division network). For example, included in the group generation condition 32 is the total number of communication apparatuses 10 that are present on the network when generating the network group, the number of network groups that are generated, or the like. The correspondence table 33 contains identification information that identifies the data which corresponds to the metadata, and information that associates a network group to which the communication apparatus 10 that retains the metadata belongs. The correspondence table 33, which will be described below, is dynamically generated when the metadata is acquired. Instead of generating the correspondence table 33, the communication apparatus 10 may retain the setting table 37. Regarding each network group, the setting table 37 is used for setting the metadata that is retained by the communication apparatus 10 in the network group. Set to be in the setting table 37 is a range of the identification information on the data that corresponds to the metadata that is retained by every network group.

The group table 34 contains information on the communication apparatus 10 that is included on the network. The communication apparatus 10 participates in a blockchain network, and because of this, retains an electronic certificate or the like that is used when having access to the blockchain network. The information on the communication apparatus 10 that is permitted to participate in a new blockchain network is notified to the communication apparatus 10 that already participates in the blockchain network. For this reason, each communication apparatus 10 retains information on any other communication apparatus 10 that is included on the network to which the communication apparatus 10 itself belongs, as the group table 34. The group table 34, for example, may be a list of pieces of identification information on the communication apparatuses 10 that are included in the network. The network group information 36 is information that possibly specifies each of the network groups that are obtained by the division. An example of the network group information 36 will be described below.

The control circuit 20 has a determination circuit 21, a verification circuit 22, a sharing control circuit 23, and an acquisition circuit 24. Using the group generation condition 32, the determination circuit 21 determines to which division network the communication apparatus 10 itself belongs. The determination circuit 21 may identify to which any other division network 10 any other communication apparatus on the network also belongs. A verification circuit 22 performs processing that verifies the obtained result of the computation. The verification circuit 22 also performs processing that verifies access to the metadata or access to the data. The sharing control circuit 23 performs control for sharing the metadata among the division networks. When there is a request for acquisition of metadata and data from the communication apparatus 10, any other communication apparatus 10, the acquisition circuit 24 performs processing that acquires the data of which the acquisition is requested.

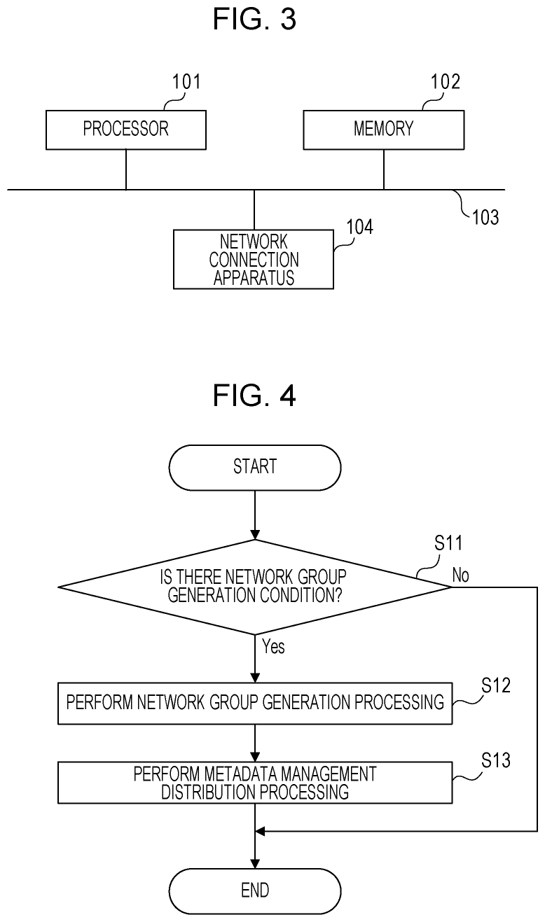

FIG. 3 is a diagram for describing an example of a hardware configuration of the communication apparatus 10. The communication apparatus 10 has a processor 101, a memory 102, a bus 103, and a network connection apparatus 104. The processor 101 is an arbitrary processing circuit, and for example, may be set as a central processing unit (CPU). The processor 101 performs a program using the memory 102 as a working memory, and thus performs various processing operations. The memories 102 include a random access memory (RAM), and also include a nonvolatile memory such as a read only memory (ROM). Stored in the memory 102 is a program or data that is used for processing in the processor 101. The network connection apparatus 104 is used for communication with any other apparatus via a network. The bus 103 connects between the processor 101, the memory 102, and the network connection apparatus 104 in such a manner that input and output into and from each other are possible.

In the communication apparatus 10, the memory 102 operates as the memory 30. The processor 101 operates as the control circuit 20. The network connection apparatus 104 operates the communication circuit 11.

### First Embodiment

A description of a first embodiment will be divided below into a description of the division of the network and a description of processing for communication over a network that results from the division. In the following description, the communication apparatus 10 as operates as a gateway apparatus. For example, the communication apparatus 10 may operate as a gateway (GW) apparatus on a network on which a server that is a source which provides data is included, and may operate as a gateway apparatus on a network on which a user's terminal that acquires data is included.

(1) Division of the Network

FIG. 4 is a flowchart for describing an example of a method of dividing a network. FIG. 4 illustrates an outline of processing that divides the network, for description. The determination circuit 21 determines whether or not a state of the network satisfies a condition for generating the network group, which is set to be in the group generation condition 32 (Step S11). In a case where the state of the network does not satisfy the condition for generating the network group, the determination circuit 21 ends the processing that divides the network (No in Step S11).

In a case where the state of the network satisfies the condition for generating the network group, the determination circuit 21 performs processing that generates the network group, using information in the group generation condition 32 (Yes in Step S11 and Step S12). Thereafter, in an individual network group, in order to manage the metadata that is acquirable through the communication apparatus 10 in each network group, metadata management distribution processing is performed (Step S13).

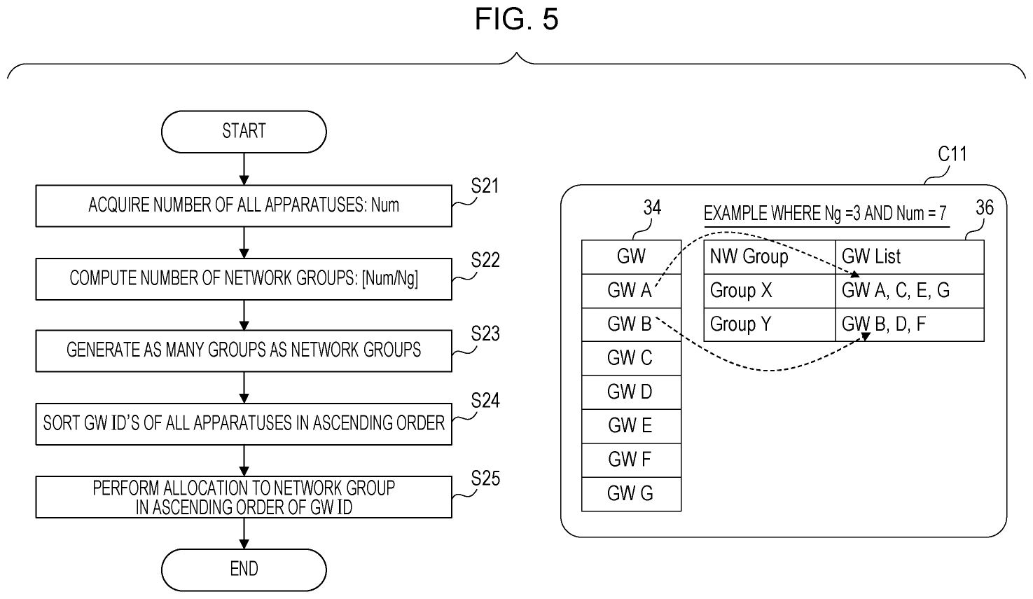

FIG. 5 is a diagram for describing an example of the method of generating the network group. FIG. 5 illustrates Step S12 in FIG. 4 in detail. In an example in FIG. 5, it is assumed that, as the group generation condition 32, the number (Ng) of communication apparatuses 10 that are included in one network group. In this case, when the total number of communication apparatuses 10 on the network exceeds the number (Ng) of communication apparatuses 10 that are included in one network group, the determination circuit 21 determines that the condition for generating the network group is satisfied.

The determination circuit 21 obtains the total number of communication apparatuses 10 that are included in the group table 34, and thus acquires the number (Num) of all communication apparatuses 10 that are included in the network (Step S21). The determination circuit 21 divides the number (Num) of all communication apparatuses 10 that are included on the network by the number (Ng) of communication apparatuses 10 that are included on one network group, and thus computes the number of network groups that are generated (Step S22). In a case where Num/Ng is not an integer, the determination circuit 21 drops numbers after a decimal point. The determination circuit 21 determines as many group identifiers as network groups, and thus performs group generation (Step S23). At a point in time for Step S23, the communication apparatus 10 is not allocated to each group.

Next, the determination circuit 21 sorts all communication apparatuses 10 that are included in the group table 34, in ascending order of an identifier (GW ID) that is allocated to the communication apparatus 10 (Step S24). The determination circuit 21 allocates each communication apparatus 10 to a network group in ascending order of the GW ID (Step S25).

The flowchart that is illustrated in FIG. 5 is an example of the processing. For example, Steps S23 and S24 may be performed in reverse order. For example, a change may also be made from a method of computing the number of network groups to any other method, such as rounding up a first decimal number after a decimal point of a value of Num/Ng to the next highest multiple and dropping the remaining numbers after the decimal point. Processing may be changed according to implementation. For example, the order in which identifiers of the communication apparatuses 10 are sorted is changed to descending order of the identifier.

A case C11 in FIG. 5 is an example of generating the network group. GW IDs of seven communication apparatus 10, identifiers of communication apparatuses GW A, GW B, GW C, GW D, GW E, GW F, and GW G are included in the group table 34 that is illustrated in the case C11. In the group table 34 in the case C11, the communication apparatuses 10 are sorted in ascending order of the ID. Using the group table 34, the determination circuit 21 recognizes that the number (Num) of communication apparatuses 10 on the network is 7. It is assumed that the number (Ng) of communication apparatuses 10 that are included in one network group is 3. The determination circuit 21 computes Num/Ng=7/3, drops numbers after a decimal point, and thus determines the number of network groups as 2.

It is assumed that the determination circuit 21 determines Group X and Group Y as identifiers of the network groups. Next, the determination circuit 21 allocates the communication apparatus 10 to the network group. In the case C11 that is an example, the determination circuit 21 allocates the communication apparatus 10 that is identified as GW A, to Group X, and the communication apparatus 10 that is identified as GW B, to Group Y. In the same manner, each of the communication apparatuses 10 that are identified as GW C to GW G, respectively, is also allocated to a network group. A result of the allocation to each network group is illustrated in a GW list. In the case C11, the communication apparatuses 10 that are identified as GW A, GW C, GW E, and GW G, respectively, are allocated to Group X. In the same manner, the communication apparatuses 10 that are identified as GW B, GW D, and GW F, respectively, are allocated to Group Y. The identifier of the network group and the information on the communication apparatus 10 that is included in each the network group are retained as the network group information 36. Therefore, in a stage where the computation of the number of network groups is finished, the network group information 36 is a result of the computation of the number of network groups.

Incidentally, the computation for generating the network group as a result of the division of the network is individually performed in each communication apparatus 10. For example, based on the same group generation condition 32, each communication apparatus 10 on the network individually computes the number of network groups. Processing is performed in any one of the communication apparatuses 10 based on the same group generation condition 32. Because of this, the result of the computation of the number of network group is expected to be the same in any one of the communication apparatuses 10, but there is no confirmation that the same result of the computation is actually obtained. Thus, the verification circuit 22 transmits and receives the result of the computation of the number of network groups to and from any other communication apparatus 10 on the network, using the communication circuit 11 suitably, and performs verification of whether or the result of the computation of the number of network groups is the same between the communication apparatus 10 and any other communication apparatus 10.

In the following description, in some cases, in order to definitely determine the communication apparatus 10 that performs an operation, an alphabet that is the rearmost part of a code that is allocated to the communication apparatus 10 which performs the operation is written after the end of a code. For example, a determination circuit 21a is a determination circuit 21 of the communication apparatus 10a.

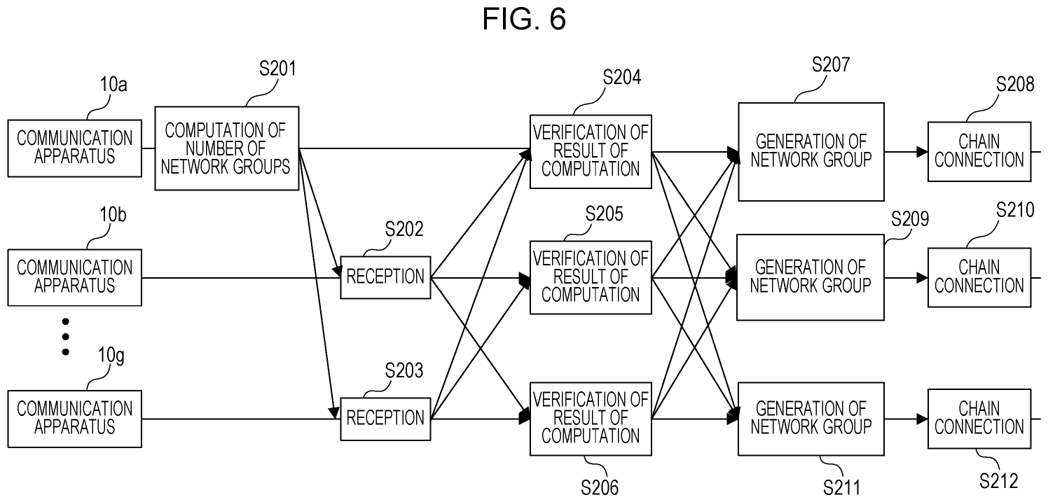

FIG. 6 is a diagram for describing an example of the verification processing. An example of processing in a case where the communication apparatus 10a initially computes the number of network groups as a leader GW is described with reference to FIG. 6, but the leader GW may be arbitrarily selected. First, the determination circuit 21a of the communication apparatus 10a computes the number of pieces of identification information of the network groups that are generated, and the number of times of allocation of the communication apparatus 10 to each network group, using a group table 34a or a group generation condition 32a (Step S201). The verification circuit 22a transmits a result of the computation that is obtained in the determination circuit 21a, to any other communication apparatus 10 on the network (Steps S202 and S203). In FIG. 6, for easy viewing, the communication apparatuses 10c to 10f are not illustrated, but it is assumed that the result of the computation of the number of network groups are transmitted to all communication apparatuses 10b to 10g. Each communication apparatus 10 that receives the result of the communication from the communication apparatus 10a transfers the received information to any other communication apparatus 10.

In the communication apparatus 10b, the verification circuit 22b performs determination of whether or not the communication apparatus 10a is a normal user of the blockchain network, or checking of whether or not the information that is transmitted from the communication apparatus 10a is correct (Step S205). In Step S205, when it is checked whether or not the information that is transmitted from the communication apparatus 10a is correct, a determination circuit 21b of the communication apparatus 10b computes the number of network groups using a group table 34b or a group generation condition 32b. The verification circuit 22b determines whether or not the result of the computation that is transmitted from the communication apparatus 10a is the same as a result of the computation by the determination circuit 21b. In a case where both the results are the same, the verification circuit 22b determines that the result of the computation which is transmitted by the communication apparatus 10a is correct. In any other communication apparatus 10, with the same processing as in the communication apparatus 10b, verification of the result of the computation in the communication apparatus 10a is performed (Steps S204 and S206).

The verification circuit 22 of each of the communication apparatus 10a to 10g transmits the obtained result of the verification to any other communication apparatus 10 on the network. Each communication apparatus 10 transmits the result of the checking of whether or not the result of the computation in the communication apparatus 10a is the same as the result of the computation in the communication apparatus 10 itself, to communication apparatuses 10 other than the communication apparatus 10 itself. Because of this, in a stage where the transmission and reception of the result of the verification are finished, each of all communication apparatuses 10 on the network may acquire the results of the checking in the communication apparatuses 10 other than the communication apparatuses 10 itself.

In the communication apparatus 10a, the verification circuit 22a determines whether or not the result of the computation of the number of network groups, which is obtained in the determination circuit 21a is the same as the results that are obtained in the communication apparatuses 10 that account for a prescribed percent or more of the apparatuses 10 on the network. The verification circuit 22a determines that the result of the computation of the number of network groups, which is obtained in the communication apparatus 10a is the same as the results that are obtained in the communication apparatuses 10 that account for the prescribed percent or more of the communication apparatuses 10 on the network. The determination circuit 21a sets the network group based on the result of the computation (Step S207). The network group that is set is as indicated by information that is currently retained, as network group information 36a, by the communication apparatus 10a. A sharing control circuit 23a deletes as much metadata as is retained in the network group to which the communication apparatus 10a does not belong, from metadata DB 35a and records a history of the deletion in the distributed ledger 31a that is the blockchain (Step S208).

It is assumed that, in the communication apparatus 10b, the verification circuit 22b determines that the result of the computation by the determination circuit 21b is the same as the result of the computation that is obtained in the communication apparatus 10a. It is assumed that, with the transmission and reception of the result of the verification, it is determined that the network group that is consistent with the result of the computation that is obtained in the communication apparatus 10a is obtained in the communication apparatuses 10 that account for the prescribed percent or more of the communication apparatuses 10 on the network. The verification circuit 22b determines that the network group is set based on the result of the computation in the determination circuit 21b, and sets the network group (Step S209). The sharing control circuit 23b deletes the metadata that is managed in the network group to which the communication apparatus 10b belong, from a metadata DB 35b, and records a history of the deletion in a distributed ledger 31b that is the blockchain (Step S210). The same processing is also performed in any other communication apparatus 10.

In a case where a different result of the computation is obtained in one or several of the communication apparatuses 10, with the transmission and reception of the result of the verification, the results of the computation that are in the communication apparatuses 10 that account for the prescribed percent or more of the communication apparatuses 10 on the network. For example, it is assumed that a result of the computation in a determination circuit 21g is different from the result of the computation in the communication apparatus 10a. However, it is assumed that, with the transmission and reception of the result of the verification, a verification circuit 22g determines that the network group that is consistent with the result of the computation that is obtained in the communication apparatus 10a is obtained in the communication apparatuses 10 that account for the prescribed percent or more of the communication apparatuses 10 on the network. The verification circuit 22g determines that the network group that is consistent with the result of the computation that is obtained in the communication apparatus 10a is set (Step S211). In this case, because the result of the computation in the determination circuit 21g is retained in a network group information 36g, information that is different from that on the network group that is set is included in the network group information 36g. Thus, the verification circuit 22g updates the network group information 36g, conforming with a detail of the setting of the network group. Therefore, in a stage where update processing is finished, content of the network group information 36g is as indicated by the network group that is actually set. The sharing control circuit 23g deletes the metadata in the network groups that are set, which is managed in the network group in which the communication apparatus 10g is not included, from the metadata DB 35g, and records the history of the deletion in the distributed ledger 31b (Step S212).

As described with reference to FIG. 6, in the method according to the first embodiment, individual communication apparatuses 10 compute the number of network groups, and mutually verify the result of the computation. Therefore, the network group that are verified by the communication apparatuses 10 that account for the prescribed percent or of the communication apparatuses 10 on the network may be generated differently than in a case where the network group is generated in a specific apparatus.

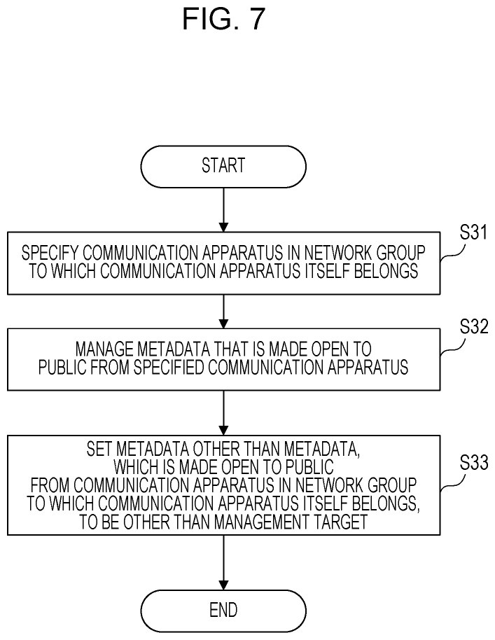

FIG. 7 is a diagram for describing an example of a method of managing metadata according to the first embodiment. When the network group is definitely determined, the sharing control circuit 23 specifies the communication apparatus 10 that is included in the network group to which the communication apparatus itself belongs (Step S31). The sharing control circuit 23 sets the metadata that is open to the public from the communication apparatus 10 that is specified in Step S31, to be a management target (Step S32). The sharing control circuit 23 sets metadata other than the metadata, which is open to the public from the communication apparatus 10 in the network group to which the communication apparatus 10 itself to which the sharing control circuit 23 belongs, to be other than the management target (Step S33). The sharing control circuit 23 not only deletes the metadata that, in Step S33, is set to be other than the management target, from the metadata DB 35, but also writes a record of the deletion of the metadata in the distributed ledger 31.

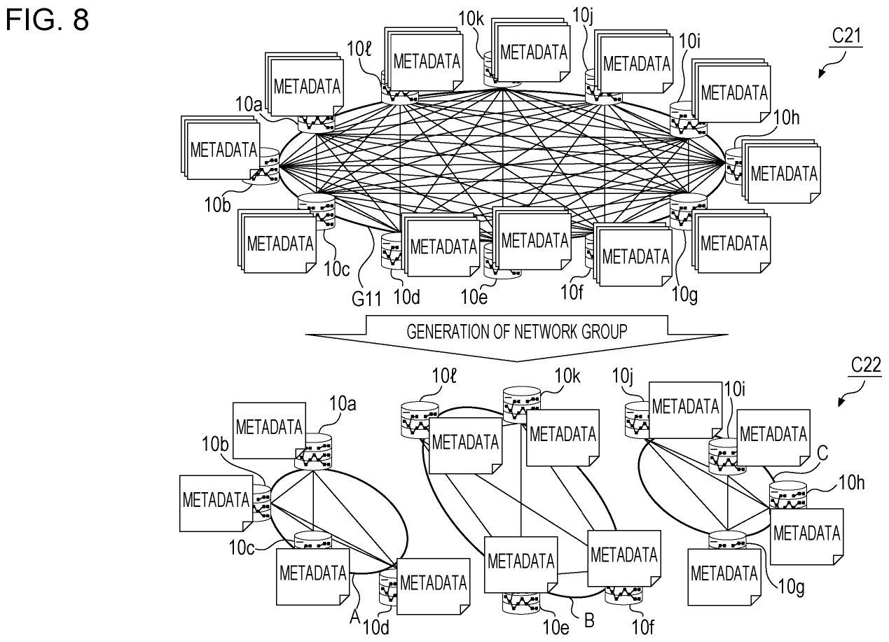

FIG. 8 is a diagram for describing an example of generating the network group. In a case C21, 12 communication apparatuses 10, communication apparatuses 10a to 10l are included in the network G11. For this reason, each communication apparatus 10 retains the metadata of the data that is acquirable through any one of the 12 communication apparatuses 10, the communication apparatuses 10a to 10l, in the metadata DB 35.

In a case C22, a case is indicated where the network G11 is divided into network groups A to C. Included in the network group A are the communication apparatuses 10a to 10d. Each of the communication apparatuses 10a to 10d may retain the metadata that is managed in four communication apparatuses 10 in the network group A, in the metadata DB 35. For this reason, a size of the metadata DB 35 is smaller than when participation in the network G11 takes place.

In the same manner, the communication apparatuses 10e, 10f, 10k, and 10l are included in the network group B, and the communication apparatuses 10g to 10j are included in the network group C. For this reason, in the communication apparatus 10 that belongs to any one of the network group B and the network group C, a capacity of the metadata DB 35 is also set to be smaller than when the participation in the network G11 takes place.

(2) Processing for Communication over the Network that Results from the Division

A description of processing for communication in a state where the division into the network groups takes place will be divided below into a description of registration of the metadata, search for the metadata, and acquisition of the metadata.

(2a) Registration of the Metadata

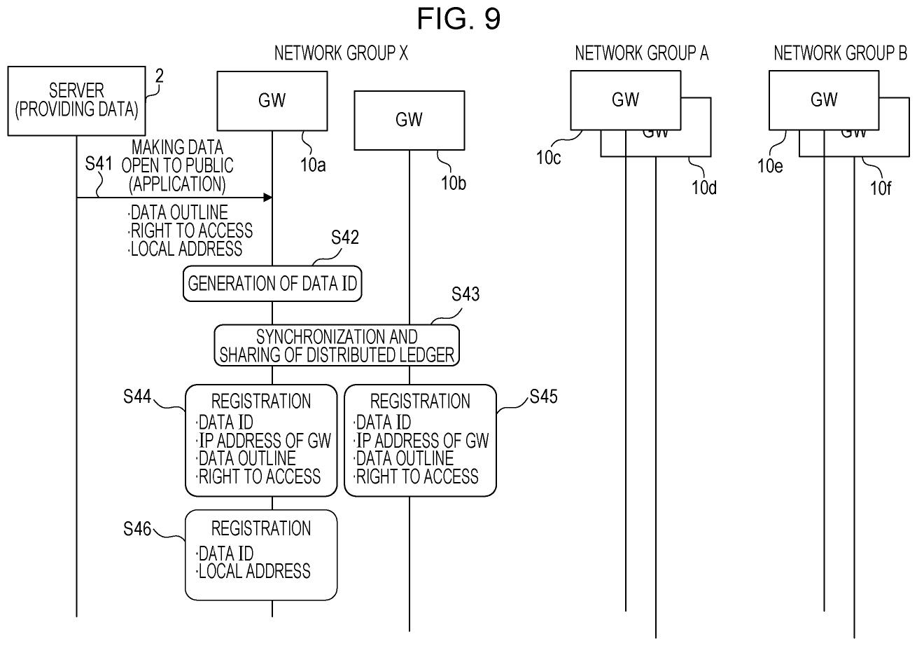

FIG. 9 is a flowchart for describing the example of the method of managing metadata according to the first embodiment. In an example in FIG. 9, the network is divided into three groups, network groups X, A, and B. The communication apparatus 10a and the communication apparatus 10b participate in the network group X. The communication apparatus 10c and the communication apparatus 10d participate in the network group A, and the communication apparatus 10e and the communication apparatus 10f participate the network group B. It is assumed that a server 2 of a provider that provides data makes a connection to the communication apparatus 10a.

The server 2 makes a request to the communication apparatus 10a for an application for making metadata of providable data open to the public (Step S41). Included in the metadata of the providable metadata are an output of the providable data, a setting of the right to the access to the metadata and the data, and a local address that is an access destination which is used when acquiring the data. Included in the local address are an internet protocol (IP) address of a local server and a path to the data.

When receiving the application for making metadata of providable data open to the public, the communication circuit 11a of the communication apparatus 10a outputs the received application to the sharing control circuit 23a. The sharing control circuit 23a generates a data ID that possibly specifies uniquely the data which is provided (Step S42). A method of generating the data ID is arbitrary. For example, the sharing control circuit 23a may set a hash value of the data that is provided, to be the data ID. The sharing control circuit 23a sets the information and the metadata ID that are received from the server 2, to be in a format of the metadata that is set in advance, and thus generates the metadata. The sharing control circuit 23a updates a distributed ledger 31a with information in the generated metadata.

The sharing control circuit 23a not only transmits the obtained metadata to any other communication apparatus 10 in the network group X, but also synchronizes information in the distributed ledger 31 (Step S43). With this processing, in the communication apparatus 10b, a history of the metadata of the data that is requested from the server 2 in Step S41 is registered in the distributed ledger 31b.

The sharing control circuit 23a of the communication apparatus 10a registers the obtained metadata in the metadata DB 35a (Step S44). In the example in FIG. 9, as the metadata, a data ID of the data that is provided from the server 2, an IP address of a GW that is an access destination, a data outline, and the right to the access are recorded. The GW that is an access destination is the communication apparatus 10 to which the server 2 makes a connection, and, because of this, has an IP address that is allocated to the communication apparatus 10a itself.

In the communication apparatus 10b, the sharing control circuit 23b registers the metadata that is received from the communication apparatus 10a, in the metadata DB 35b. Also recorded in the metadata DB 35b are the data ID of the data that is provided, the IP address of the communication apparatus 10a that is the GW which is an access destination, the data outline, and the right to the access (Step S45).

The sharing control circuit 23a of the communication apparatus 10a notifies any other apparatus of the metadata that is included in the IP address of the communication apparatus 10a itself as an access destination, and thus keeps an address of the server 2 concealed from any other apparatus. However, because the communication apparatus 10a uses information on the server 2 in order to acquire the data that is provided from the server 2, the sharing control circuit 23a registers a local address of the server 2 in a state of being associated with the data ID (Step S46).

On the other hand, the metadata of the data that is providable from the server 2 is not notified to the communication apparatuses 10c to 10f that belongs to the network group A or the network group B. For this reason, the communication apparatus 10c to 10f dispense with retention of the metadata of the data that is providable from the server 2.

FIG. 9 is an example of the processing, and the processing may be changed according to the implementation. For example, the processing in Step S44 may be performed prior to the processing in Step S43, and the processing in Step S43 and the processing in Step S44 may be performed concurrently.

As illustrated in FIG. 9, when the division into the network groups takes place, registration or management of the metadata is performed for every network group. Therefore, when information on the data that is providable from the server 2 that makes a connection to the communication apparatus 10a which belongs to the network group X is notified, the metadata that is generated from the notified information is retained in the communication apparatus 10 that belongs to the network group X. However, the metadata of the data that is providable from the server 2 that makes a connection to the communication apparatus 10a which belongs to the network group X is not retained in the communication apparatus 10 that belongs to the network group other than the network group X. For this reason, by generating the network group, an amount of metadata that is managed by the individual communication apparatus 10 may be decreased and a load that is applied to the communication apparatus 10 may be reduced.

(2b) Search for the Metadata

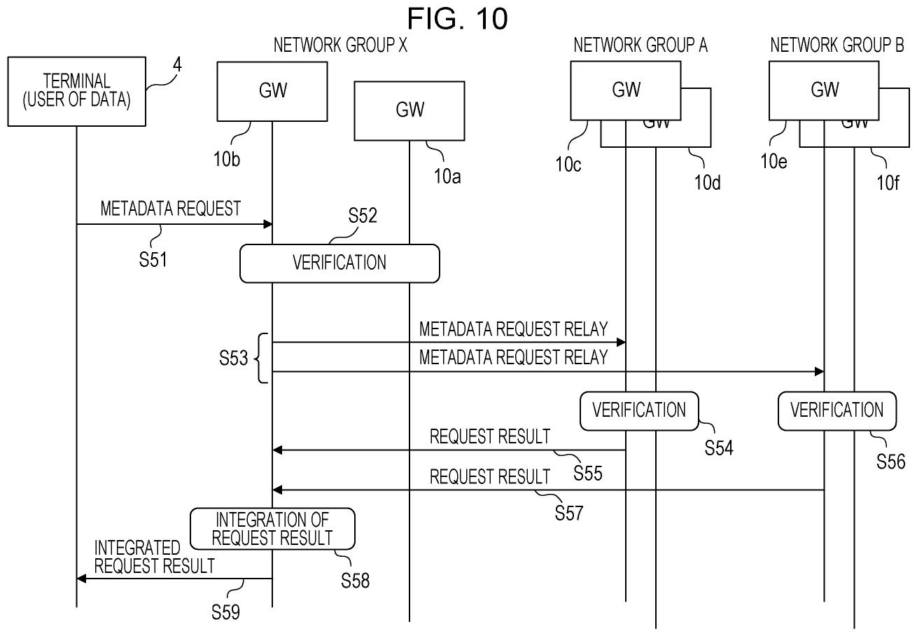

FIG. 10 is a sequence diagram for describing an example of a method of referring to the metadata according to the first embodiment. In an example in FIG. 10, it is also assumed that the network is divided into the network groups X, A, and B. It is assumed that the communication apparatus 10a and the communication apparatus 10b participate in the network group X, and the communication apparatus 10c and the communication apparatus 10d participate in the network group A. The communication apparatus 10e and the communication apparatus 10f participate in the network group B. It is assumed that a terminal 4 of a user who is going to use data is connected to the communication apparatus 10b.

It is assumed that a metadata request that is a request for information on the data that is available to the terminal 4 is transmitted from the terminal 4 of the user who is going to use the data (Step S51). At this time, not only the metadata request, but an electronic certificate that is issued to the terminal 4 is also transmitted from the terminal 4.

When receiving the metadata request and the electronic certificate, a communication circuit 11b of the communication apparatus 10b outputs the received metadata request and electronic certificate to an acquisition circuit 24b. Using the electronic certificate, the acquisition circuit 24b determines whether or not the terminal 4 is a normal user that possibly has access to the network, and whether or not the terminal 4 has the right to the access to the metadata (Step S52). For example, in a case where the terminal 4 is permitted to have access to any one of pieces of metadata that are retained in the metadata DB 35b, the acquisition circuit 24b determines that the terminal 4 has the right to the access to the metadata. The terminal 4 is designated in such a manner as to have access to metadata for the data to which the terminal 4 possibly has access, by granting the right to the access to the metadata.

The acquisition circuit 24b suitably transmits the metadata request and the electronic certificate that are transmitted from the terminal 4 to any other communication apparatus 10 in the network group X, using the communication circuit 11b, and make a request to verify whether or not the terminal 4 is a normal user and the terminal 4 has the right to the access. For this reason, in the communication apparatus 10a, verification of whether or not the terminal 4 has the right to the access or the like is also performed (Step S52).

In the example in FIG. 10, it is assumed that the communication apparatuses 10 that account for the prescribed percent or more of the communication apparatuses 10 that are included in the network group X determines that the terminal 4 is a normal user and that the terminal 4 has the right to the access to the metadata. The acquisition circuit 24b extracts the metadata for the data to which the terminal 4 possibly has access, from the metadata DB 35b. Pieces of metadata that are extracted from the metadata DB 35b include metadata that is managed in the network group X, and do not include metadata that is managed in any other network group. Thus, by referring to network group information 36b, the acquisition circuit 24b transfers the metadata request to the communication apparatus 10 in a network group other than the network group X (Step S53). At this time, the acquisition circuit 24b selects a destination of transfer of the metadata request to each of the network group A and the network group B, using the network group information 36b. In the example in FIG. 10, the acquisition circuit 24b selects the communication apparatus 10c and the communication apparatus 10e from the network group A and the network group B, respectively, as the destination of the transfer of the metadata request.

When receiving the metadata request through a communication circuit 11c, an acquisition circuit 24c of the communication apparatus 10c determines whether or not the terminal 4 has the right to the access to the metadata that is retained in the network group A (Step S54). In a case where the terminal 4 is permitted to have access to any pieces of metadata that are retained in a metadata DB 35c, the acquisition circuit 24c determines that the terminal 4 has the right to the access to the metadata that is retained in the network group A. The acquisition circuit 24c transmits the metadata request to any other communication apparatus 10 in the network group A through the communication circuit 11c, and makes a request for verification of whether or not the terminal 4 has the right to the access to the metadata. For this reason, verification of whether or not the terminal 4 has the right to the access is also performed in the communication apparatus 10d (Step S54). It is assumed that the communication apparatuses 10 that account for the prescribed percent or of the communication apparatuses 10 that are included in the network group A determines that the terminal 4 has the right to the access to the metadata that is retained in the network group A. The acquisition circuit 24c extracts the metadata for the data to which the terminal 4 possibly has access, from the metadata DB 35c, and as a result of the request, transmits the extracted metadata to the communication apparatus 10b (Step S55).

The same processing as described with reference to Steps S54 and S55 is also performed in the communication apparatus 10e in the network group B (Steps S56 and S57). For this reason, among pieces of metadata that are retained in the network group B, the data to which the terminal 4 possibly has access is also transmitted to the communication apparatus 10b.

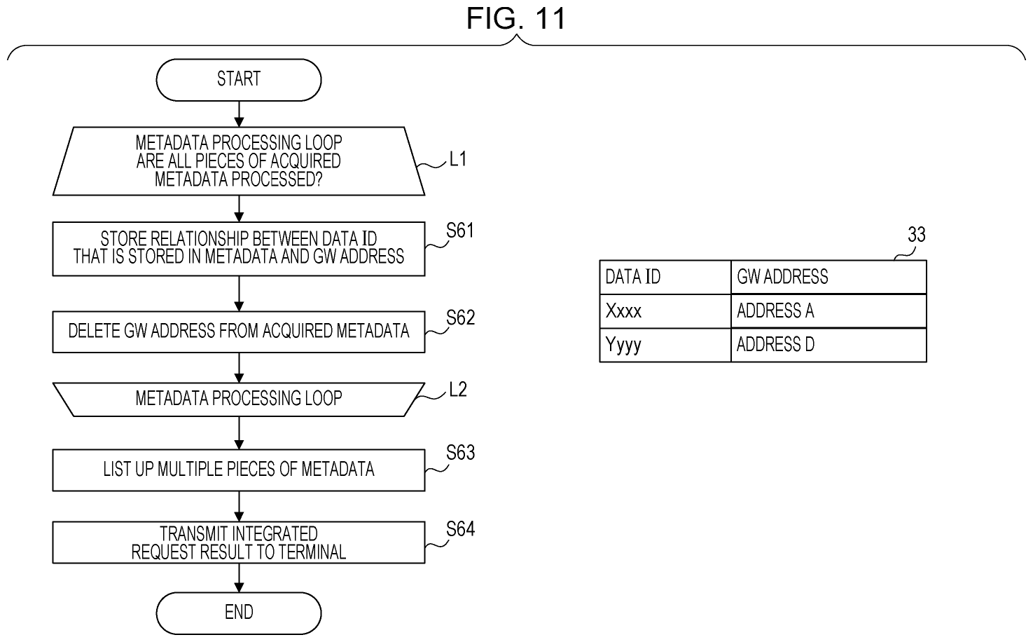

The acquisition circuit 24b of the communication apparatus 10b integrates a request result that is received from the communication apparatus 10 in any other network group, and the metadata that is extracted by the acquisition circuit 24b from the metadata DB 35b, and thus generates an integrated request result (Step S58). Processing that generates the integrated request result is described in detail with reference to FIG. 11. The acquisition circuit 24b transmits the obtained integrated request result to the terminal 4 (Step S59).

As described with reference to FIG. 10, when the network is divided into multiple network groups and then the metadata is requested from the terminal 4, each network group is searched for the metadata to which the terminal 4 possibly has access and all search results are notified to the terminal 4. For this reason, in the method according to the embodiment, the information in the metadata that is retained in a network group other than a network group to which the communication apparatus 10 that is a connection destination of the terminal 4 belongs is also provided to the terminal 4.

FIG. 11 is a diagram for describing an example of processing of the request result. When receiving the request result from the communication apparatus 10 in any other network group, the acquisition circuit 24 performs loop processing from a loop terminal L1 to a loop terminal L2. In some cases, the loop processing from the loop terminal L1 to the loop terminal L2 will be written below as “metadata processing loop”. The acquisition circuit 24 determines whether or not the processing is performed on all pieces of acquired metadata (the loop terminal L1). In a case where the processing is not performed on the all pieces of acquired metadata, the acquisition circuit 24 stores a relationship between the data ID that is written into the metadata and a GW address, in the correspondence table 33 (No in the loop terminal L1 and Step S61). For example, it is assumed that pieces of information, data ID=Xxxx and GW address=address A, are included in the metadata that is a first processing target. The acquisition circuit 24 stores the information, data ID=Xxxx, in the correspondence table 33 in a state of being associated with the information, GW address=address A. It is assumed that pieces of information, data ID=Yyyy and GW address=address B, are included in the metadata that is a second processing target. In this case, the acquisition circuit 24 also stores the information, GW address=address B, in the correspondence table 33 in a state of being associated with data ID=Yyyy. For this reason, the correspondence table 33 that is illustrated in FIG. 11 is obtained.

When the processing in Step S61 is finished, the acquisition circuit 24 deletes the GW address from the acquired metadata (Strep S62). With the processing in Step S62, an address of the communication apparatus 10 that possibly makes a connection to the source that provides data, of which an outline is recorded in the metadata is kept concealed from the terminal 4. Among pieces of acquired metadata, there remain pieces of metadata that are not yet processed, the processing in the metadata processing loop is repeated (the loop terminal L2).

When performing the processing in the metadata processing loop on the all pieces of acquired metadata, the acquisition circuit 24 lists multiple pieces of post-processing metadata, and thus generates the integrated request result (Step S63). The acquisition circuit 24 transmits the integrated request result to the terminal 4 of the user who transmits the metadata request (Step S64).

With the processing that is described with reference to FIG. 11, the integrated request result that is obtained by listing outlines of pieces of data that are available to the terminal 4 may be transmitted to the terminal 4 while the information on the communication apparatus 10 to which the source that provides data makes a connection is kept concealed from the terminal 4.

(2c) Acquisition of Data

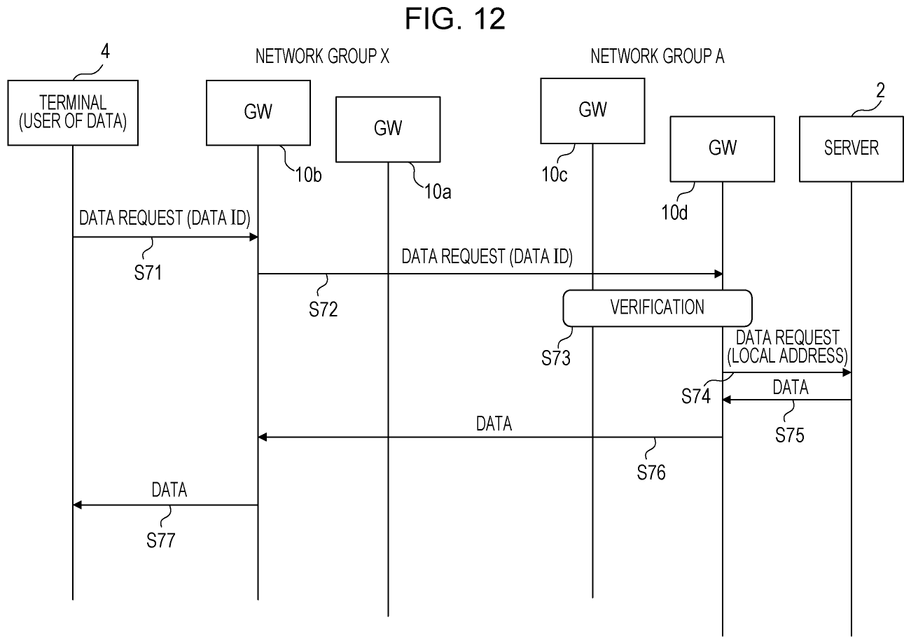

FIG. 12 is a sequence diagram for describing an example of a method of acquiring data according to the first embodiment. An example of processing that is performed in a case where the terminal 4 that is connected to the communication apparatus 10b acquires data that is identified with data ID=Yyyy is described with reference to FIG. 12. It is assumed that an address D is an IP address that is allocated to the communication apparatus 10d.

It is assumed that a user of the terminal 4 that acquires the integrated request result acquires data that is identified with data ID=Yyyy, using the data outline that is included in the integrated request result. By an operation by the user of the terminal 4, a data request that includes data ID=Yyyy is transmitted from the terminal 4 (Step S71). At this time, along with the data request, the electronic certificate that is issued to the terminal 4 is also transmitted to the communication apparatus 10b.

The acquisition circuit 24b of the communication apparatus 10b receives the data request through the communication circuit 11b. The acquisition circuit 24b searches a correspondence table 33b for the data ID, as a key, that is included in the data request. It is assumed that the correspondence table 33b is as illustrated in FIG. 11. The acquisition circuit 24b specifies that GW address=address D is associated with data ID=Yyyy. Thus, the acquisition circuit 24b transfers the data request to the communication apparatus 10 (the communication apparatus 10d) to which the address D is allocated (Step S72). At this time, along with the data request, the electronic certificate that is transmitted from the terminal 4 is also transferred to the communication apparatus 10d. The acquisition circuit 24b stores the information that a transmission source of the data request is the terminal 4, in a state of being associated with the data ID.

An acquisition circuit 24d of the communication apparatus 10d acquires the metadata request and the electronic certificate through a communication circuit 11d. The acquisition circuit 24d stores the information that a transfer destination of the data request is the communication apparatus 10b, in a state of being associated with the data ID. Using the electronic certificate, the acquisition circuit 24d determines whether or not the terminal 4 is a normal user that possibly has access to the network, and whether or not the terminal 4 has the right to the access to the data that is identified with data ID=Yyyy (Step S73). Whether or not the terminal 4 has the right to the access to the data that is identified with data ID=Yyyy is determined, depending on whether or not the terminal 4 is permitted to have access to metadata that includes data ID=Yyyy.

The acquisition circuit 24d suitably transmits the metadata request and the electronic certificate to any other communication apparatus 10 in the network group A, using the communication circuit 11d, and make a request to verify whether or not the terminal 4 is a normal user and the terminal 4 has the right to the access. For this reason, in the communication apparatus 10c, the verification of whether or not the terminal 4 has the right to the access or the like is also performed (Step S73). In an example in FIG. 12, it is assumed that the communication apparatuses 10 that account for the prescribed percent or more of the communication apparatuses 10 that are included in the network group A determines that the terminal 4 is a normal user and that the terminal 4 has the right to the access to the data that is identified with data ID=Yyyy.

Because an address of the communication apparatus 10d itself is recorded in the metadata, the acquisition circuit 24d determines that the data which is identified with data ID=Yyyy may be acquired from an apparatus that makes a connection to the communication apparatus 10d. The acquisition circuit 24d transmits the data request to a local address that is stored in a state of being associated with data ID=Yyyy (Step S74).

When receiving the data request, the server 2 regards the data which is associated with the local address that is a destination of the data request, as data that is transmitted in response to the data request. Included in the local address is a path to the data in addition to an address of a local server (the server 2). For this reason, data that is selected as a target that is to be transmitted in response to the data request that is transmitted in Step S74 is data that is identified with data ID=Yyyy. The server 2 transmits data that is specified as the target that is transmitted in response to the data request, to the communication apparatus 10d that is the transmission source of the data request (Step S75).

The acquisition circuit 24d of the communication apparatus 10d specifies a transfer destination of the data that is received from the server 2, using the data ID. The transfer destination of the data with data ID=Yyyy is the communication apparatus 10b that is the transfer destination of the data request. Thus, the acquisition circuit 24d transmits the data that is identified with data ID=Yyyy, to the communication apparatus 10b (Step S76).

The acquisition circuit 24b of the communication apparatus 10b specifies the transfer destination of the data that is received from the communication apparatus 10d, using the data ID. Because the request for the data with data ID=Yyyy is transmitted from the terminal 4, the transfer destination of data ID=Yyyy is the terminal 4. Thus, the acquisition circuit 24b transmits the data that is identified with data ID=Yyyy, to the terminal 4 (Step S77).

As described with reference to FIG. 12, when the network is divided into multiple network groups and then data is requested from the terminal 4, the communication apparatus 10 may specify a request destination of the data, using the correspondence table 33 that is created, when metadata is searched for. For this reason, in the method according to the embodiment, data that is retained in a network group other than a network group to which the communication apparatus 10 that is the connection destination of the terminal 4 belongs is also provided to the terminal 4.

### Second Embodiment

In the first embodiment, the case is described where each communication apparatus 10 that is categorized as belonging to the network group retains the metadata of the data that is acquirable through any one of the communication apparatuses 10 in the network group to which the communication apparatus 10 itself belongs. However, the network group in which metadata is retained may not be the network group to which the communication apparatus 10 to which the source that provides data, which is specified with the metadata, belongs.

In the second embodiment, a case is described where the network group in which the metadata is retained is selected regardless of the network group to which the communication apparatus 10 to which the source that provides data makes a connection belongs. The second embodiment is the same as the first embodiment except for processing that determines metadata which is a management target, in the processing that is performed when the network is divided into multiple network groups.

(3a) Determination of the Metadata that is the Management Target

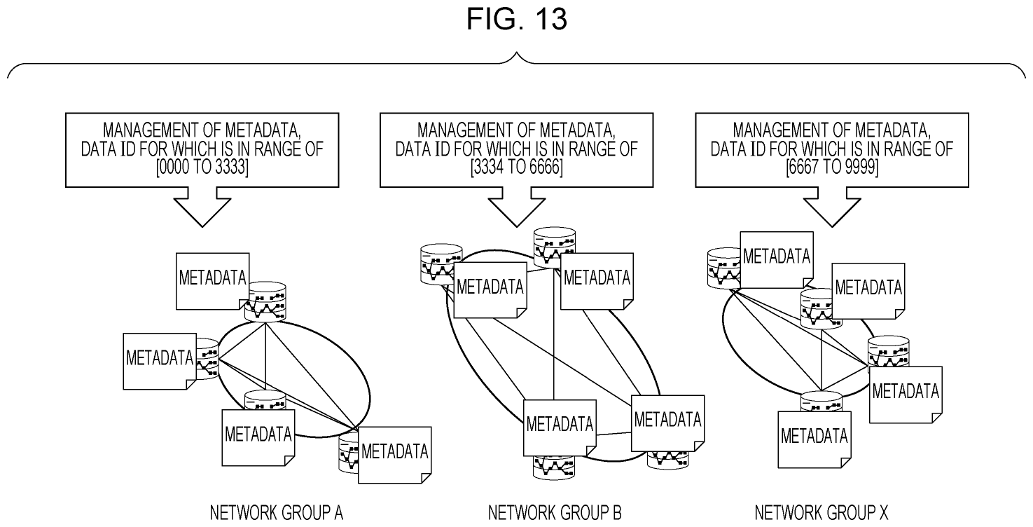

FIG. 13 is a diagram for describing an example of a method of managing metadata according to the second embodiment. In the second embodiment, a range of IDs of pieces of data that retain metadata is set in advance for each network group. It is assumed that a range of values that the data ID takes is from 0000 to 9999.

In an example in FIG. 13, each of the communication apparatuses 10 that belong to the network group A retains the metadata, the data ID for which is included in a range of 0000 to 3333. The distributed ledger 31 that is retained by the communication apparatus 10 that belongs to the network group A is also used when checking a history of, or the legitimacy of, the access to the metadata, the data ID for which is included in the range of 0000 to 3333.

In the same manner, each of the communication apparatuses 10 that belong to the network group B retains the metadata, the data ID for which is included in a range of 3334 to 6666, and the distributed ledger 31 that is available for checking the history of, or the legitimacy of, the access to the metadata, the data ID for which is in the range of 3334 to 6666. Each of the communication apparatuses 10 that belongs to the network group X retains the metadata, the data ID for which is included in a range of 6667 to 9999, and the distributed ledger 31 that is available for checking the history of, or the legitimacy of, the access to the metadata, the data ID for which is in the range of 6667 to 9999.

In the second embodiment, each communication apparatus 10 stores a range in which the metadata in each network group is retained, as the setting table 37. In an example in FIG. 13, each communication apparatus 10 retains the setting table 37 that includes the following information. data IDs=0000 to 3333: network group A

data IDs=3334 to 6666: network group B

data IDs=6667 to 9999: network group X

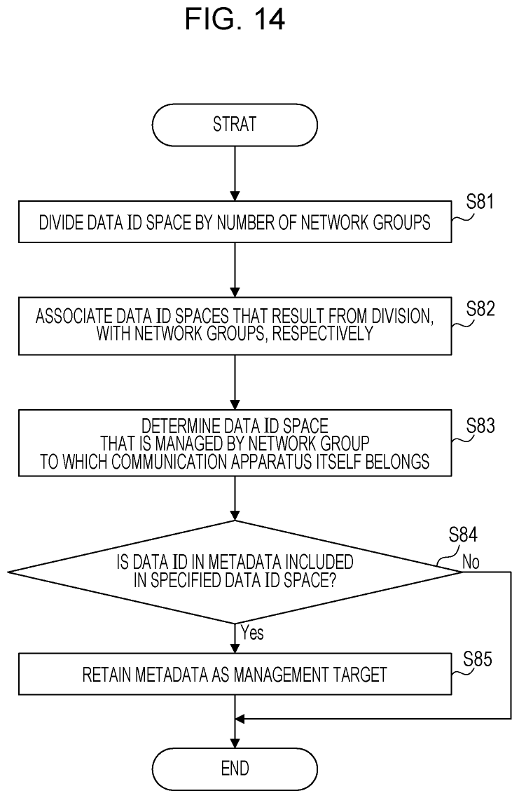

FIG. 14 is a flowchart for describing the example of the method of managing metadata according to the second embodiment. In the following description, in some cases, a range of values that the data ID takes is expressed as “data ID space”.

It is assumed that verification of the computation of the number of network groups for dividing the network and of the result of the computation of the number of networks groups is finished. Each communication apparatus 10 retains information on the generated network group in the network group information 36. Thus, by referring to the network group information 36, the sharing control circuit 23 may specify the number of network groups that are generated. The sharing control circuit 23 divides the data ID space by the number of network groups and associates data ID spaces that result from the division, with the network groups, respectively (Steps S81 and S82). With the division processing in Steps S81 and S82, for example, as described with reference to FIG. 13, the ID space that results from the division is associated with each network group. The sharing control circuit 23 specifies the data ID space that is managed by the network group to which the communication apparatus 10 itself (Step S83).

When setting the network group, the sharing control circuit 23 determines whether or not, for individual metadata that is retained in the metadata DB 35, the data ID is included in a specified data ID space (Step S84). In a case where the data ID in the metadata is included in the specified data ID, the sharing control circuit 23 retains the metadata, as a management target, in the metadata DB 35 (Yes in Step S84 and Step S85). The sharing control circuit 23 updates the distributed ledger 31 with information such as the history of the metadata as the management target.

On the other hand, in a case where the data ID in the metadata is not included in the specified data ID space, the sharing control circuit 23 determines that the metadata is not the management target (No in Step S84). In this case, the sharing control circuit 23 deletes the metadata from the metadata DB 35. The sharing control circuit 23 does not include the information in the metadata that is not the management target, in the distributed ledger 31.

The deletion of the metadata from the metadata DB 35 that follows when setting the network group is described with reference to FIG. 14, but in a case where the metadata is acquired after setting the network group, it is determined whether or not the metadata is stored using the same procedure as in FIG. 14.

(3b) Registration of the Metadata

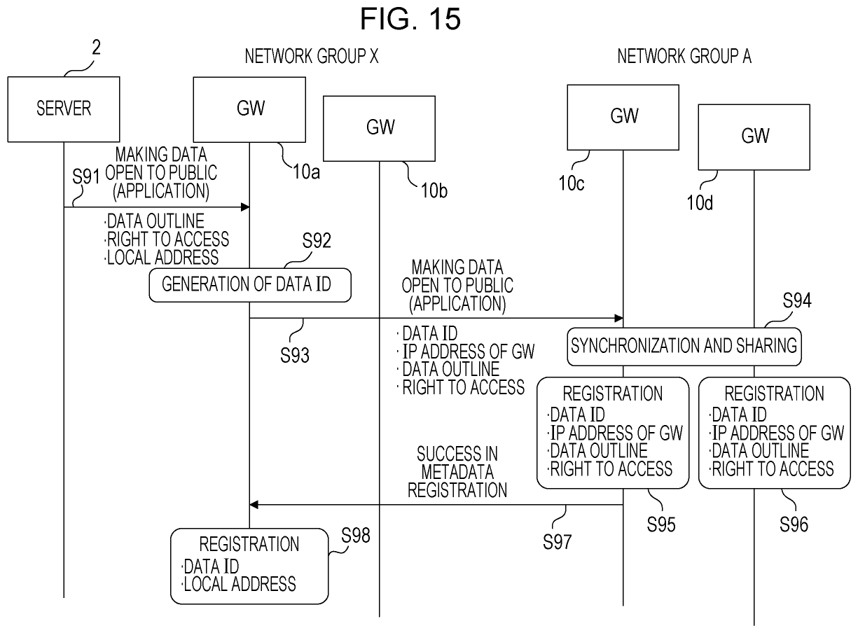

FIG. 15 is a sequence diagram for describing an example of the method of managing metadata according to the second embodiment. In an example in FIG. 15, the communication apparatus 10a and the communication apparatus 10b participate in the network group X, and the communication apparatus 10c and the communication apparatus 10d participate in the network group A. The server 2 that possibly provides data is connected to the communication apparatus 10a.

The server 2 makes a request to the communication apparatus 10a for the application for making metadata of providable data open to the public (Step S91). The outline of the providable data, the setting of the right to the access to the metadata and the data, and the local address that is an access destination that is used when acquiring the data are transmitted, as information on the providable data, to the communication apparatus 10a. The server 2 also transmits the electronic certificate that is issued to the server 2 to the communication apparatus 10a, along with the application for making metadata open to the public.

When acquiring the application for making metadata open to the public or the electronic certificate through the communication circuit 11a, the sharing control circuit 23a of the communication apparatus 10a determines whether or not the server 2 is a normal user, using the electronic certificate. When it is determined that the server 2 is a normal user, the sharing control circuit 23a generates the data ID from data that is a target that is made open to the public (Step S92). The sharing control circuit 23a searches the setting table 37 for the generated data ID as a key. It is assumed that the data ID which is generated in Step S92 is included in a range where the network group A retains the metadata.

By referring to the network group information 36a, the sharing control circuit 23a selects the communication apparatus 10 that is included in the network group A, as a notification destination of the metadata. A method of selecting the communication apparatus 10 that is the notification destination of the metadata is arbitrary. For example, the sharing control circuit 23 may set the communication apparatus 10 that is randomly selected from among the communication apparatuses 10 that are listed as the communication apparatuses that belong to the network group A, as the notification destination of the metadata. In a case where a leader GW that operates as a leader of each network group is set in advance, the sharing control circuit 23 may select the leader GW of the network group A, as the notification destination of the metadata. In the example in FIG. 15, the sharing control circuit 23a selects the communication apparatus 10c as the notification destination of the metadata.

The sharing control circuit 23a transmits the metadata that includes the data ID, the IP address of the GW that is the access destination, the data outline, and the right to the access, to the communication apparatus 10c (Step S93). In Step S93, in order to conceal the address of the server 2, the sharing control circuit 23a includes the IP address that is allocated to the communication apparatus 10a, as the IP address of the GW that is the access destination, in the metadata that is to be transmitted to the communication apparatus 10c.

When acquiring the metadata through the communication circuit 11c, a sharing control circuit 23c of the communication apparatus 10c records the information in the metadata, in the distributed ledger 31c. The sharing control circuit 23c not only transmits the obtained metadata to any other communication apparatus 10 in the network group A, but also synchronizes the information the distributed ledger 31 (Step S94). With this processing, in the communication apparatus 10d, a history of the metadata that is received by the communication apparatus 10c in Step S93 is also registered in a distributed ledger 31d.

The sharing control circuit 23c of the communication apparatus 10c records the metadata that is received from the communication apparatus 10a, in the metadata DB 35c (Step S95). The data ID of the data that is provided from the server 2, the IP address of the GW that is the access destination, the data outline, and the right to the access are recorded, as the metadata, in the metadata DB 35c. The GW that is the access destination has an IP address that is allocated to the communication apparatus 10a, as designated in the communication apparatus 10a when the processing in Step S93 is performed.

In the communication apparatus 10d, a sharing control circuit 23d registers the metadata that is received from the communication apparatus 10c, in a metadata DB 35d. Also recorded in the metadata DB 35d are the data ID of the data that is provided, the IP address of the communication apparatus 10a that is the GW which is the access destination, the data outline, and the right to the access (Step S96).

When the metadata that is notified by the communication apparatus 10a is registered in the metadata DB 35c, the sharing control circuit 23c of the communication apparatus 10c notifies the communication apparatus 10a that the registration of the metadata succeeds (Step S97). When notified that the registration of the metadata succeeds, the sharing control circuit 23a of the communication apparatus 10a registers the local address of the server 2 in a state of being associated with the data ID (Step S98). The information that is registered in Step S98 is used when the communication apparatus 10a acquires data that is provided from the server 2 as a proxy server and transmits the acquired data to any other communication apparatus 10, the terminal 4, or the like.

In this manner, in the second embodiment, although the communication apparatus 10 that is a connection destination of the server 2 belongs to the network group X, the metadata is not retained in the network group X, depending on a value of the data ID.

(3c) Search for the Metadata

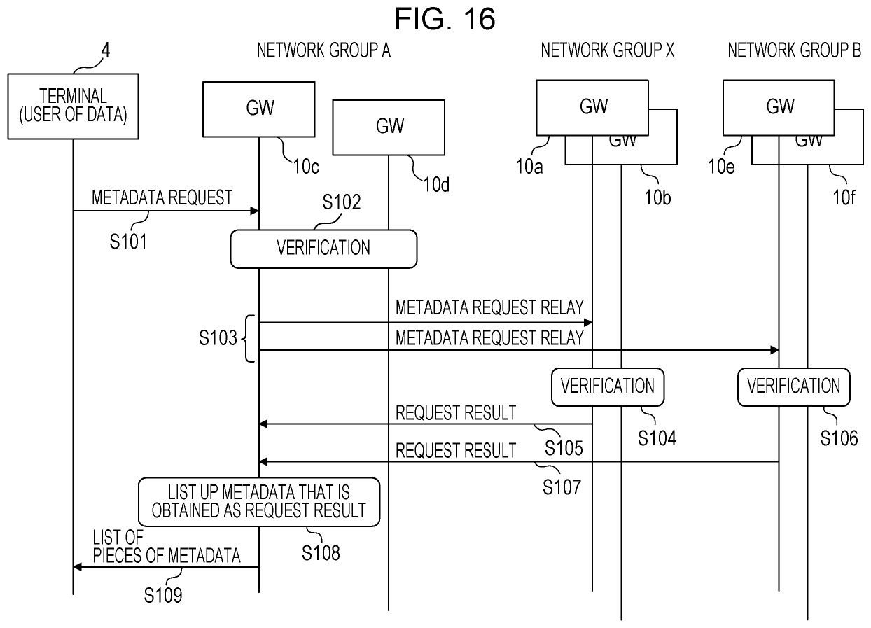

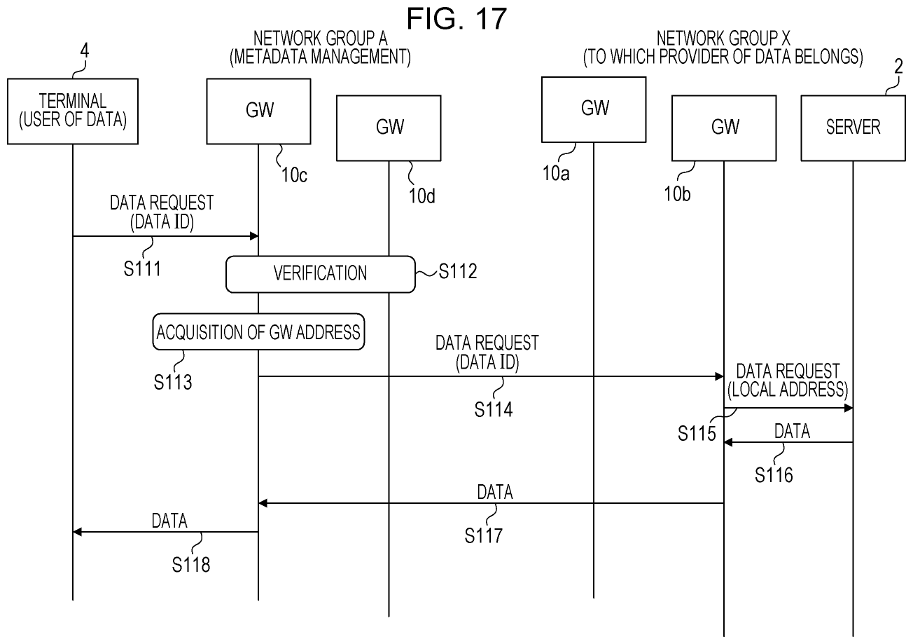

FIG. 16 is a sequence diagram for describing an example of the method of referring to the metadata according to the second embodiment.

In an example in FIG. 16, it is assumed that the communication apparatus 10a and the communication apparatus 10b participate in the network group X, and the communication apparatus 10c and the communication apparatus 10d participate in the network group A. It is assumed that the communication apparatus 10e and the communication apparatus 10f participate in the network group B. It is assumed that the terminal 4 of the user who uses data is connected to the communication apparatus 10c.

It is assumed that the metadata request that is a request for the information on the data that is available to the terminal 4 and the electronic certificate that is issued to the terminal 4 are transmitted from the terminal 4 that is going to use data to the communication apparatus 10c (Step S101). The processing operations that are performed in Step S102 and S107 are the same as the processing operations that are described with reference to Step S52 to S57 in FIG. 10.

Thereafter, the sharing control circuit 23c lists pieces of metadata that are extracted, as pieces of metadata to which the terminal 4 possibly has access, from the metadata DB 35c, and the metadata that is included in the request result which is obtained in Step S105 and S107 (Step S108). At this time, in order to conceal the information on the communication apparatus 10 to which the source that provides data makes a connection, from the terminal 4, the sharing control circuit 23c lists pieces of information that result from deleting the IP address of the GW that is the access destination, from each piece of metadata. The sharing control circuit 23c transmits a list of pieces of metadata that are obtained in Step S108, to the terminal 4 through the communication circuit 11c (Step S109).

In this manner, in a case where a target that retains the metadata is determined in advance using the data ID space, the correspondence table 33 is not generated when the metadata is searched for. Because of this, the processing by the communication apparatus 10 may be simplified, compared with the first embodiment. In the second embodiment, a request for the metadata is relayed to all networks groups. Because of this, the information in the metadata that is retained in a network group other than the network group to which the communication apparatus 10 that is the connection destination of the terminal 4 belongs is also provided to the terminal 4.

(3d) Acquisition of Data

FIG. 17 is a sequence diagram for describing an example of a method of acquiring data according to the second embodiment. An example of acquiring data in a case where the data, the registration of whose metadata in the network group A is performed in the processing that is illustrated in FIG. 15, is requested from the terminal 4 will be described with reference to FIG. 17. In an example in FIG. 17, it is assumed that the terminal 4 is connected to the communication apparatus 10c in the network group A and that the server 2 is connected to the communication apparatus 10b in the network group X.

It is assumed that the user of the terminal 4 that acquires the list of pieces of metadata determines data that is identified with data ID=0414, using the outline that is included in the list of pieces of metadata. By the operation by the user of the terminal 4, the data request that includes data ID=0414 and the electronic certificate that is issued to the terminal 4 are transmitted from the terminal 4 to the communication apparatus 10c (Step S111).

The acquisition circuit 24c of the communication apparatus 10c receives the data request and the electronic certificate through the communication circuit 11c. The acquisition circuit 24c searches a setting table 37c for the data ID, as a key, that is included in the data request, and thus specifies that the metadata of the data which is an acquisition target is retained in the network group A. The acquisition circuit 24c stores the information that the transmission source of the data request is the terminal 4, in a state of being associated with the data ID. Using the electronic certificate, the acquisition circuit 24c determines whether or not the terminal 4 is a normal user that possibly has access to the network, and whether or not the terminal 4 has the right to the access to the data that is identified with data ID=0414 (Step S112). In a case where the terminal 4 is permitted to have access to the metadata that includes data ID=0414, the acquisition circuit 24c determines that the terminal 4 has the right to the access to the data that is identified with data ID=0414.

The acquisition circuit 24c suitably transmits the metadata request and the electronic certificate to any other communication apparatus 10 in the network group A, using the communication circuit 11c, and make a request to verify whether or not the terminal 4 is a normal user and the terminal 4 has the right to the access. For this reason, in the communication apparatus 10d, the verification of whether or not the terminal 4 has the right to the access or the like is also performed (Step S112). In the example in FIG. 17, it is assumed that the communication apparatuses 10 that account for the prescribed percent or more of the communication apparatuses 10 that are included in the network group A determines that the terminal 4 is a normal user and that the terminal 4 has the right to the access to the data that is identified with data ID=0414.

The acquisition circuit 24c acquires the IP address of the GW that is an access destination, which is recorded in the metadata (Step S113). It is assumed that an address of the communication apparatus 10b is recorded, as an access destination, in the metadata of the data that is identified with data ID=0414. The acquisition circuit 24c transmits the data request that includes data ID=0414, to the communication apparatus 10b (Step S114).

The acquisition circuit 24b of the communication apparatus 10b receives the data request through the communication circuit 11b. The acquisition circuit 24b stores the information that the transmission source of the data request is the communication apparatus 10c, in a state of being with data ID=0414. The acquisition circuit 24b transmits the data request to the local address (including the IP address of the server 2 and a path to the data with data ID=0414) that is stored in a state of being associated with data ID=0414 (Step S115).

When receiving the data request, the server 2 transmits the data that is identified with the local address, to the communication apparatus 10b that is the transmission source of the data request (Step S116). Because the path to the data with data ID=0414 is included in the local address, the data that is transmitted to the communication apparatus 10b is the data that is identified with data ID=0414.

The acquisition circuit 24b of the communication apparatus 10b specifies the transfer destination of the data that is received from the server 2, using the data ID. The transfer destination (the transmission source of the data request) of the data with data ID=0414 is the communication apparatus 10c. Thus, the acquisition circuit 24b transmits the data that is identified with data ID=0414, to the communication apparatus 10c (Step S117).

The acquisition circuit 24c of the communication apparatus 10c specifies the transfer destination of the data that is received from the communication apparatus 10b, using the data ID. The transfer destination of the data with data ID=0414 is the terminal 4. Thus, the acquisition circuit 24c transmits the data that is identified with data ID=0414, to the terminal 4 (Step S118).

As described with reference to FIG. 17, the request destination of the data that is determined using the GW that is the access destination that is included in the metadata of the data that is requested by the data requested. For this reason, the communication apparatus 10 in the network group that retains the metadata may also provide data that is provided from the server 2 that is not connected to the communication apparatus 10 in the network group to which the communication apparatus 10 itself belongs, to the terminal 4.

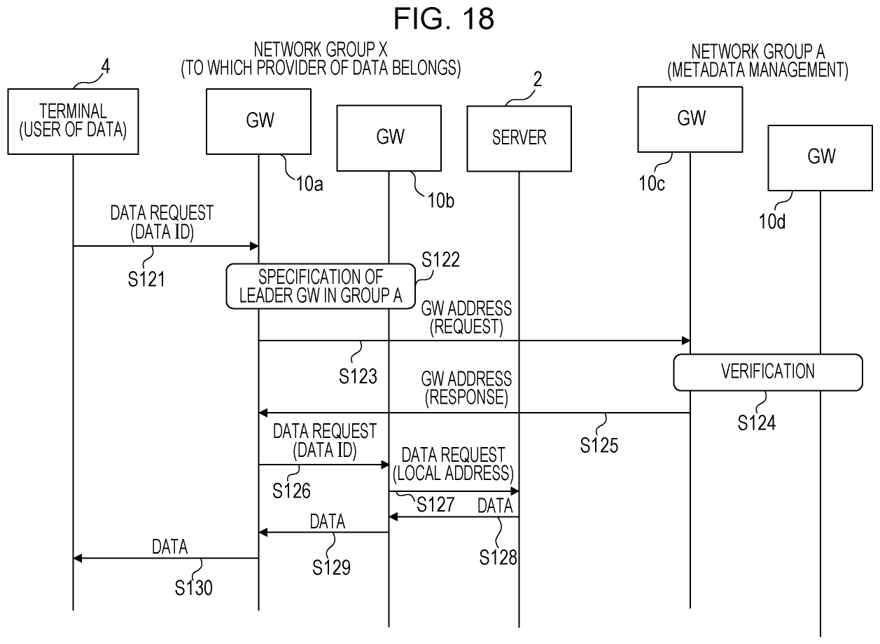

FIG. 18 is a sequence diagram for describing an example of the method of acquiring data according to the second embodiment. An example in a case where the terminal 4 that is going to acquire data is connected to the network group that does not manage the metadata is described with reference to FIG. 18. In FIG. 18, any one of the terminal 4 that is going to acquire data and the server 2 that is the source that provides data is connected to the network group X, but it is assumed that the metadata of the data that is provided is managed in the network group A. In an example in FIG. 18, it is assumed that the leader GW in each network group is determined when the network group is generated and is recorded in the network group information 36.

It is assumed that the user of the terminal 4 that acquires the list of pieces of metadata determines data that is identified with data ID=2542, using the outline that is included in the list of pieces of metadata. By the operation by the user of the terminal 4, the data request that includes data ID=2542 and the electronic certificate that is issued to the terminal 4 are transmitted from the terminal 4 to the communication apparatus 10a (Step S121).

An acquisition circuit 24a of the communication apparatus 10a acquires the data request and the electronic certificate through the communication circuit 11a. The acquisition circuit 24a searches a setting table 37a for the data ID, as a key, that is included in the data request, and thus specifies that the metadata of the data which is an acquisition target is retained in the network group A. The acquisition circuit 24a stores the information that the transmission source of the data request is the terminal 4, in a state of being associated with the data ID. By referring to the acquisition circuit 24a, the network group information 36a specifies the leader GW in the network group A (Step S122). In the example in FIG. 18, it is assumed that the communication apparatus 10c is the leader GW in the network group A. The acquisition circuit 24a transmits a request message (a GW address request) that requests the address of the communication apparatus 10 that is the destination of the data request, and the electronic certificate that is received from the terminal 4, to the communication apparatus 10c (Step S123). Included in the GW address is data ID=2542 that identifies the data that is the acquisition target.

The acquisition circuit 24c of the communication apparatus 10c receives the GW address request and the electronic certificate through the communication circuit 11c. The acquisition circuit 24c stores the information that the transmission source of the GW address request is the communication apparatus 10a. Using the electronic certificate, the acquisition circuit 24c determines whether or not the terminal 4 is a normal user that possibly has access to the network, and whether or not the terminal 4 has the right to the access to the data that is identified with data ID=2542 (Step S124). The acquisition circuit 24c transmits both the GW address request and the electronic certificate to any other communication apparatus 10 in the network group A and makes a request to verify whether or not the terminal 4 is a normal user and the terminal 4 has the right to the access. In the example in FIG. 18, it is assumed that the communication apparatuses 10 that account for the prescribed percent or more of the communication apparatuses 10 in the network group A determines that the terminal 4 is a normal user that possibly has access to the network and that the terminal 4 has the right to the access to the data that is identified with data ID=2542.

The acquisition circuit 24c reads the metadata that includes data ID=2542, from the metadata DB 35c, and acquires the GW address that is the access destination that is included in the metadata. It is assumed that the address of the communication apparatus 10b is designated, as the GW address that is an access destination, as being in the metadata for data ID=2542. The acquisition circuit 24c transmits a message (a GW address response) for notifying the address of the communication apparatus 10b, to the communication apparatus 10a (Step S125).

The acquisition circuit 24a of the communication apparatus 10a acquires the GW address response through the communication circuit 11a. The address of the communication apparatus 10b is written, as the access destination of the data with data ID=2542, into the GW address response. Thus, the acquisition circuit 24a transmits the data request that designates data ID=2542, to the communication apparatus 10b (Step S126).

The acquisition circuit 24b of the communication apparatus 10b receives the data request through the communication circuit 11b. The acquisition circuit 24b stores the information that the transmission source of the data request is the communication apparatus 10a, in a state of being associated with data ID=2542. The acquisition circuit 24b transmits the data request to the local address (including the IP address of the server 2 and the path to the data with data ID=2542) that is stored in a state of being associated with data ID=2542 (Step S127).

When receiving the data request, the server 2 transmits the data that is identified with the local address, to the communication apparatus 10b that is the transmission source of the data request (Step S128). Because the path to the data with data ID=2542 is included in the local address, the data that is transmitted to the communication apparatus 10b is the data that is identified with data ID=2542.

The acquisition circuit 24b of the communication apparatus 10b specifies the transfer destination of the data that is received from the server 2, using the data ID. The transfer destination (the transmission source of the data request) of the data with data ID=2542 is the communication apparatus 10a. Thus, the acquisition circuit 24b transmits the data that is identified with data ID=2542, to the communication apparatus 10a (Step S129).

The acquisition circuit 24a of the communication apparatus 10a specifies the transfer destination of the data that is received from the communication apparatus 10b, using the data ID. The transfer destination (the transmission source of the data request) of the data with data ID=2542 is the terminal 4. Thus, the acquisition circuit 24a transmits the data that is identified with data ID=2542, to the terminal 4 (Step S130).

In FIG. 18, the example of the case where the communication apparatus 10a inquires the leader GW in the network group A of the GW address is described, but this is only an example. The communication apparatus 10a may inquire the communication apparatus 10, which is not the leader GW in the network group A, of the address of the communication apparatus 10 that is the access destination.

As described with reference to FIG. 18, in a case where the metadata is not retained, the communication apparatus 10 that receives the data request inquires the communication apparatus 10 in the network group, which retains the metadata, of the communication apparatus 10 that is an access destination of the data. For this reason, even in the metadata is not retained in the network group to which any one the connection destination of the terminal 4 and the connection destination of the server 2, the terminal 4 may provide data, of which acquisition is requested by the terminal, to the terminal 4.

### Others

Moreover, embodiments are limited to the embodiments described above, and various modifications to the embodiments described above are possible. Examples of the modifications will be described below.

The correspondence table 33, the group table 34, the network group information 36, and the setting table 37, which are described above, are only examples. Information elements that are included in the correspondence table 33, the group table 34, the network group information 36, the setting table 37, and the like may be changed according to the implementation.

The case where the network groups are generated according to the number of communication apparatuses 10 on the network is described above, but a condition for generating the network groups is not limited to the number of communication apparatuses 10. For example, when an amount of delay that occurs when communication is performed among communication apparatuses 10 on the network exceeds a prescribed value, the network may be divided into multiple network groups. In this case, in an individual network group, the delay that occurs when communication is performed is set in such a manner as to fall below a prescribed value.

A path for the communication among the network groups may also be changed according to the implementation. For example, the path for the communication among the network groups may be changed in such a manner as to be performed through the leader GW in the individual network group. Furthermore, the communication apparatus 10 other than the leader GW may communicate with the communication apparatus 10 that does not operate as the leader GW in any other network group or the communication apparatus 10 that operates as the leader GW.

A timing at which the leader GW is determined may also be changed arbitrarily according to the implementation. For example, the leader GW may be set when the network group is generated. At a timing at which the transmission and reception of the result of the computation of the number of network groups, the leader GW may be set.

The group generation condition 32 may also be set arbitrarily. For example, the group generation condition 32 may be information that dynamically determines the network group. In this case, information as to which network group to participate in when the division into the network groups takes place in the individual communication apparatus 10 is designated as being in the group generation condition 32. The determination circuit 21 in the individual communication apparatus 10 determines the network group according to the designated information in the group generation condition 32.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication apparatus comprising:
a memory configured to store a distributed ledger in which metadata of data that is acquirable through any one of a plurality of communication apparatuses that belongs to a network; and
a processor coupled to the memory and configured to:
control for sharing the distributed ledger among the plurality of communication apparatuses,
determine in which one of a plurality of division networks that are obtained by dividing the network participation takes place, using the same rule as any other communication apparatus that belongs to the network, when a communication situation of the network satisfies a predetermined condition, and
control for sharing the distributed ledger among communication apparatuses in the division network that is determined.

2. The communication apparatus according to claim 1, wherein the processor is configured to:
communicate with any other communication apparatus that belongs to the network,
determine in which one of the plurality of division networks any other communication apparatus that belongs to the network participates,
transmit and receive a result of computation of the number of the plurality of division networks to and from a communication apparatus that belongs to the network, and
when the result of the computation is the same as results that are obtained in apparatuses that account for a predetermined percent or more of the plurality of communication apparatus, share the distributed ledger among the division networks that are determined.

3. The communication apparatus according to claim 1, wherein the processor is configured to:
receive a request for registration of metadata of provision data that is provided by a terminal from the terminal that makes a connection to the communication apparatus, and
notify any other communication apparatus in a division network to which the communication apparatus is allocated, of the metadata of the provision data.

4. The communication apparatus according to claim 1,
wherein the memory is configured to store a setting table for setting a range of values of identification information of data, of which metadata is retained by a communication apparatus on the division network,
wherein the processor is configured to:
receive a request for registration of metadata of provision data that is provided by a terminal from the terminal that makes a connection to the communication apparatus, and
notify a communication apparatus in a division network that is associated with identification information of the provision data in the setting table, of the metadata of the provision data.

5. The communication apparatus according to claim 1, wherein the processor is configured to:
receive a request for acquisition of metadata of target data that any other terminal is going to acquire from any other terminal that makes a connection to the communication apparatus,
make a request to a communication apparatus on any other division network that is different from a division network to which the communication apparatus is allocated, for the metadata of the target data,
acquire the metadata of the target data from the communication apparatus on any other division network, and
transfer the metadata of the target data to the any other terminal.

6. The communication apparatus according to claim 5,
wherein, for each piece of metadata that is acquired from a communication apparatus in any other division network, the processor is configured to associate identification information of data that is included in the metadata and any other division network.

7. The communication apparatus according to claim 6, wherein the processor is configured to:
receive a request from any other terminal to acquire the target data, and
make a request to a communication apparatus in a division network that is associated with identification information that identifies the target data, for the target data.

8. The communication apparatus according to claim 4, wherein the processor is configured to:
receive a request from any other terminal that makes a connection to the communication apparatus, to acquire target data that any other terminal is going to acquire, and
make a request to a communication apparatus in a division network that is associated with identification information that identifies the target data, in the setting table, for an address of an access destination for acquiring the target data.

9. A communication method executed by a processor included in each of a plurality of communication apparatuses that belong to a network, the method comprising:
storing a distributed ledger in which metadata of data that is acquirable through any one of a plurality of communication apparatuses that belongs to a network;
controlling for sharing the distributed ledger among the plurality of communication apparatuses;
determining in which one of a plurality of division networks that are obtained by dividing the network participation takes place, using the same rule as any other communication apparatus that belongs to the network, when a communication situation of the network satisfies a predetermined condition; and
controlling for sharing the distributed ledger among communication apparatuses in the division network that is determined.

10. The communication method according to claim 9, further comprising:
communicating with any other communication apparatus that belongs to the network;
determining in which one of the plurality of division networks any other communication apparatus that belongs to the network participates;
transmitting and receiving a result of computation of the number of the plurality of division networks to and from a communication apparatus that belongs to the network; and
when the result of the computation is the same as results that are obtained in apparatuses that account for a predetermined percent or more of the plurality of communication apparatus, sharing the distributed ledger among the division networks that are determined.

11. The communication method according to claim 9, further comprising:
receiving a request for registration of metadata of provision data that is provided by a terminal from the terminal that makes a connection to the communication apparatus; and
notifying any other communication apparatus in a division network to which the communication apparatus is allocated, of the metadata of the provision data.

12. The communication method according to claim 9, further comprising:
storing a setting table for setting a range of values of identification information of data, of which metadata is retained by a communication apparatus on the division network;
receiving a request for registration of metadata of provision data that is provided by a terminal from the terminal that makes a connection to the communication apparatus; and
notifying a communication apparatus in a division network that is associated with identification information of the provision data in the setting table, of the metadata of the provision data.

13. The communication method according to claim 9, further comprising:
receiving a request for acquisition of metadata of target data that any other terminal is going to acquire from any other terminal that makes a connection to the communication apparatus;
making a request to a communication apparatus on any other division network that is different from a division network to which the communication apparatus is allocated, for the metadata of the target data;
acquiring the metadata of the target data from the communication apparatus on any other division network; and
transferring the metadata of the target data to the any other terminal.

14. A non-transitory computer-readable recording medium storing a program that causes a processor included in each of a plurality of communication apparatuses to execute a process, the process comprising:
storing a distributed ledger in which metadata of data that is acquirable through any one of a plurality of communication apparatuses that belongs to a network;
controlling for sharing the distributed ledger among the plurality of communication apparatuses;
determining in which one of a plurality of division networks that are obtained by dividing the network participation takes place, using the same rule as any other communication apparatus that belongs to the network, when a communication situation of the network satisfies a predetermined condition; and
controlling for sharing the distributed ledger among communication apparatuses in the division network that is determined.

15. The recording medium according to claim 14, the process further comprising:
communicating with any other communication apparatus that belongs to the network;
determining in which one of the plurality of division networks any other communication apparatus that belongs to the network participates;
transmitting and receiving a result of computation of the number of the plurality of division networks to and from a communication apparatus that belongs to the network; and
when the result of the computation is the same as results that are obtained in apparatuses that account for a predetermined percent or more of the plurality of communication apparatus, sharing the distributed ledger among the division networks that are determined.
